(19) United States
(12) Patent Application Publication
(10) Pub. No.: US 2010/0187388 A1
(43) Pub. Date: Jul. 29, 2010

(54) BRACKET

(76) Inventors: Daniel Woolman, Hendon (GB); Stuart Woolman, Charlotte, NC (US)

Correspondence Address: EDWARDS ANGELL PALMER & DODGE LLP, P.O. BOX 55874, BOSTON, MA, 02205, US

(21) Appl. No.: 12/692,238

(22) Filed: Jan. 22, 2010

(30) Foreign Application Priority Data
Jan. 26, 2009 (GB) 0901242.8

(51) Int. Cl. F16M 13/00

(52) U.S. Cl. 248/213.2

(57) ABSTRACT

A bracket (1) for attaching a device (51) to the upper part of a wall (53) of a container (55) comprises two parts (3, 5), the first part (3) of which secures the device to the wall while the second part (5) provides rigidity of the bracket (1) when secured in position. The first part (3) is of generally “S” shape with a horizontally extending extension (9) from the upper part of the “S” by means of which the “S” shaped part is connected to the second part (5) through a pivot (11). The second part (5) is of generally “U” shaped construction, and is movable between a first or open position in which one side (13) of the “U” extends parallel to the horizontally extending extension (9) of the first part (3) so as to effectively form an extension thereof and the second side (15) of the “U” extending parallel to the first side (13) and being connected thereto by the base part (17) of the “U” and a second or closed position in which it forms a substantially box section with first part (3).

### CROSS REFERENCES TO RELATED APPLICATION

This application claims priority to United Kingdom Patent Application No. 0901242.8 filed Jan. 26, 2009. The entire contents of the aforementioned patent application is incorporated herein by this reference.

### BACKGROUND OF THE INVENTION

This invention relates to a bracket, particularly but not exclusively to a bracket for a sanitizing device for a portable refuse container, and in particular to those commonly known as a “Wheelie Bin”.

There are hygiene problems associated with the use of wheelie bins. Rubbish is a breeding ground for disease. Bacteria can multiply extremely rapidly given the right conditions, Bacteria can grow and divide every 20 minutes. One single bacteria can become more than 8 million bacteria in less than 24 hours. Most of the germs that can be found in decaying food stuffs and other discarded organic matters can be found in wheelie bins. These include bacteria that can cause food poisoning such as Escherichia Coli, Listeria monocytogenesand Campylobacter jejuni.

Moreover the presence of vermin and flies in the bins represents a real danger to the end user and any children or immuno compromised persons living in close proximity. Flies are known carriers of germs and diseases including intestinal worms and gastroenteritis.

Sanitizing devices are known for use in “Wheelie Bins” but these suffer from a number of disadvantages. In particular, there is the problem of retaining the sanitizing device in the bin while it is in use. In many cases of council provided wheelie bins, the bins are roughly treated by the council collection machinery and while this machinery does not damage the bins themselves, they can dislodge the sanitizing device from the bin and either render it inoperable or deposit it with the rubbish in the council collection machinery and thus destroy it.

The present invention seeks to provide a bracket to which a sanitizing device can be easily fitted which can itself be easily and securely fitted to portable refuse containers, such as wheelie bins. It also seeks to provide a bracket which has a universal application to attaching sanitizers to a wheelie bin.

### BRIEF SUMMARY OF THE INVENTION

According to the invention, there is provided a bracket for attaching a device to the upper part of a wall of a container, the bracket comprising two parts, the first part of which secures the device to the wall while the second part provides rigidity of the bracket when secured in position in which the first part is of generally “S” shape with an horizontally extending extension from the upper part of the “S” by means of which the “S” shaped part is connected to the second part through a pivot, the second part being of generally “U” shaped construction, and being movable between a first or open position in which one side of the “U” extends parallel to the horizontally extending extension of the first part so as to effectively form an extension thereof and the second side of the “U” extending parallel to the first side and being connected thereto by the base part of the “U” and a second or closed position in which it forms a substantially box section with first part.

Preferably securing means is provided for securing the second part in its second position. The securing means may comprise a nut and bolt extending between horizontally extending extension of the first part and the base of the “U” of the second part.

A bolt receiving aperture in the base of the “U” may be in the form of a slot so that the relative positions of the first and second parts are adjustable.

The lower part of the “S” may have an upwardly extending generally vertical arm which is adapted to be seated in a corresponding slot in the device.

One or both of the parts of the bracket may be an extrusion. The extrusion(s) may be aluminum or plastics.

The invention also includes an arrangement comprising a bracket as described above and a sanitizer positively connected thereto.

The sanitizer may have a slot which cooperates with one arm of the lower part of the “S” and may be provided with a detent engageable behind a projection on the said one arm whereby the sanitizer is permanently attached to the bracket when the said one arm of the “S” is pushed into the slot of the sanitizer.

### BRIEF DESCRIPTION OF THE DRAWINGS

The invention will now be described in greater detail, by way of example, with reference to the drawings, in which:

FIG. 1 is a perspective opened out view of one embodiment of bracket in accordance with the invention;

FIG. 2 is a closed up perspective view of the bracket shown in FIG. 1;

FIG. 3 is a perspective view of the upper part of a “wheelie” bin showing a sanitizing device attached to the upper edge of the wheelie bin by the bracket as shown in FIGS. 1 and 2, and

FIG. 4 is a sectional view taken on the line IV—IV of FIG. 3.

### DETAILED DESCRIPTION OF THE PREFERRED EMBODIMENTS

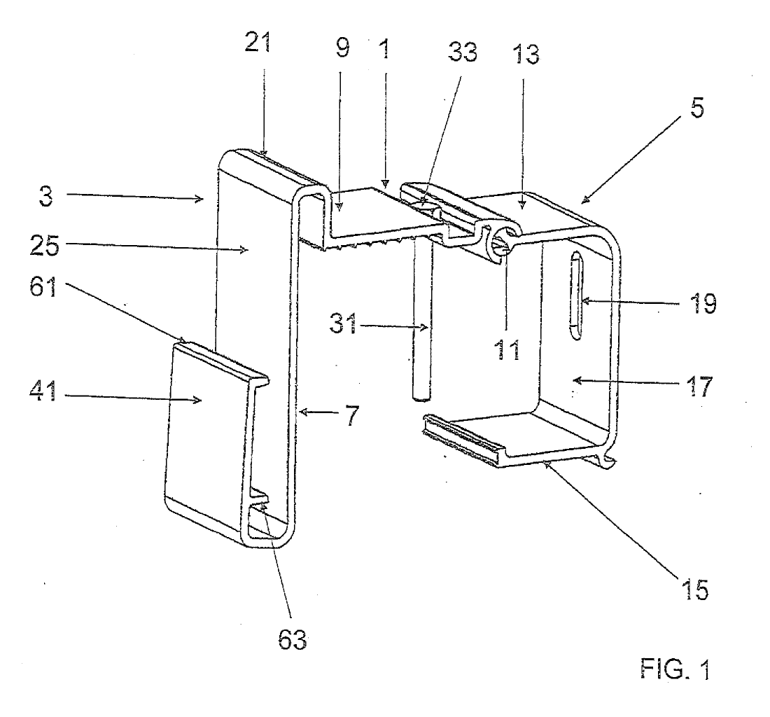

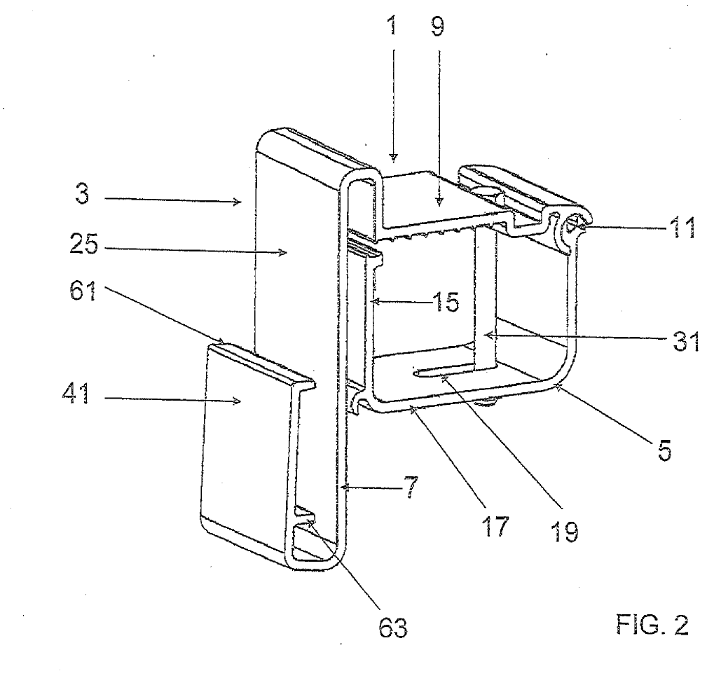

Referring to FIGS. 1 and 2 of the drawings a bracket 1 for attaching a sanitizing device to a portable refuse container such as a “wheelie bin” comprises two parts 3 and 5. The first part 3 is the part which secures the sanitizing device to the refuse container while the second part 5 provides for rigidity of the bracket when secured into position. The larger or first part 3 is of generally “S” shape 7 with a horizontally extending extension 9 by means of which the “S” shaped part 7 is connected to the second part 5. The second part 5 is connected to the first part 3 by a longitudinal pivot 11 and is of generally “U” shaped construction. In its open state, as shown in FIG. 1, one side 13 of the “U” extends parallel to the horizontally extending extension 9 of the first part 3 so as to effectively form an extension thereof. The other or second side 15 of the “U” extends parallel to the first side 13 and is connected thereto by the base part 17 of the “U”.

The base 17 of the “U” of the second part 5 has a slot 19 therein and, in the closed position as shown in FIG. 2, the second part 5 takes up a position beneath the horizontally extending extension 9 of the first part 3 so as to make a substantially box section therewith. The second side 15 of the “U” of the second part 5 forms, in effect, an extension of upper part 21 of the “S” of the first part 3 and defines a channel 23 between second side 15 of the “U” of the second part 5 and the main part 25 of the “S”. This channel 23 sits on the upper edge of the wheelie bin so that the bracket 1 is secure thereon as will be described hereafter.

The second part 5 is secured in its closed position by means of a bolt 31 which passes from a recessed aperture 33 in the horizontally extending extension 9 of the first part 3 through the slot 19 in the base 17 of the “U” on the other side of which it is secured by a nut not shown in these figures. It will be seen that the open end of the channel 23 is restricted by a rib 35 which engages against the wall of the wheelie bin and provides for a tight engagement with the wheelie bin wall. Because of the design shown, the bracket may be made from two extrusions, for example, of aluminum. In some circumstances bracket may suitably be constructed of plastics extrusions.

In order to attach the sanitizer to the bracket, the lower but vertical end 41 of the “S” will slide into a slot in the back of the sanitizer as will be explained hereafter.

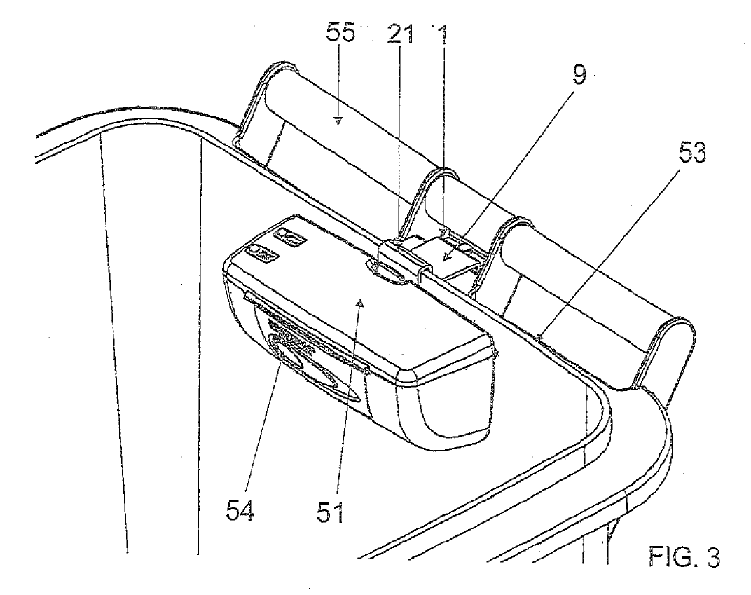

FIG. 3 shows a view of a sanitizer 51 mounted by means of the above described bracket 1 on to the rear inner wall 53 of a wheelie bin 55. As will be seen hereafter, the sanitizer 51 is firmly fixed onto the bracket 1 which in turn is firmly fixed to the wheelie bin so that it cannot be disengaged therefrom without undoing the bracket 1.

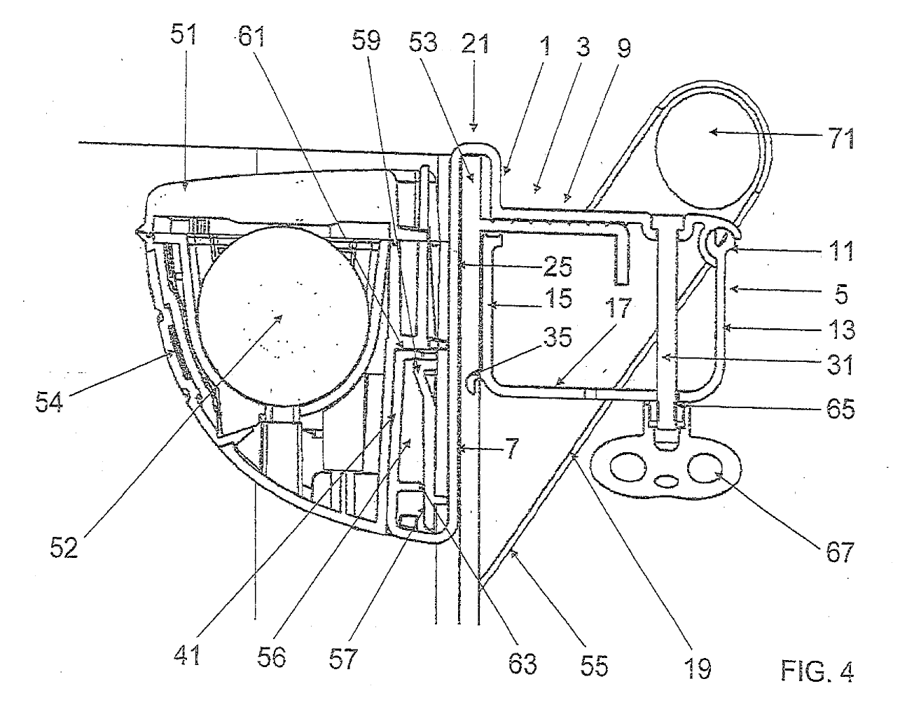

FIG. 4 shows a cross section of the sanitizer 51, the bracket 1 and the top part of the wheelie bin 55 showing how the various parts of the bracket 1 work together to provide a suitable fixing.

The operation of the bracket 1 will now be described:

Firstly the bracket 1 is taken in its open position as shown in FIG. 1 and the sanitizer 51 is attached thereto. The sanitizer may be of any suitable type and may suitably have an automatic or timed aerosol 52 using one or more spray nozzles 54. The attachment of the sanitizer 51 is achieved by sliding the lower but vertical end 41 of the “S” into the slot 56. The slot 56 has a cam surface 57 with a sprung detent 59 up which cam surface 57 a right angled portion 61 of the end 41 slides until it passes over the spring detent 59 and lodges therebehind preventing the sanitizer 51 from being removed from the bracket 1. The end 41 of the “S” is provided with a projecting rib 63 which engages the cam surface 57 and maintains the position of the sanitizer 51 stable on the bracket 1.

Then the part of the bracket 1 containing the extension 9 and the second part 5 is threaded beneath the wheelie bin handle 71 with the top part 21 of the “S” being positioned over the top of the wall 53 of the wheelie bin 55 so as to sit thereon with the wall of the “S” shaped part lying against the wall 53 of the wheelie bin 55.

With the parts in this position, the second part 5 of the bracket 1 can be pivoted about its pivot 11 into the position shown in FIG. 2. In this position, the rib 35 will be pressed against the outer surface of the wall 53 of the wheelie bin 55. The side 15 of the “U” will, in this position form with the main “S” shaped part the slot 23 previously referred to and in which the wall 53 of the wheelie bin 55 is sandwiched. All that then remains is for the bolt 31 to be threaded through between the extension 9 of the first part 3 of the bracket 1 and the base 17 of the “U” of the second part 5 of the bracket using the aperture 33 in the extension 9 and the slot 19 in the base 17 of the “U”, the bolt being secured in position by means of a nut 65, suitably operated by a detachable key 67. With this final securing of the bracket, the bracket will assume a substantially box like structure providing a very rigid attachment to the wheelie bin 55.

If it is desired to remove the sanitizer from the bin, the bolt 31 can be undone and the bracket removed in the opposite way to its assembly. However, it will be noted that the sanitizer cannot be removed from the bracket and, should the sanitizer need replacing, a new bracket must also be used.

It will be observed that the above described bracket is of a generally universal design in that the projection 35 is adjustable to adjust for different thicknesses of bin wall, this adjustment being allowed by the use of the slot 19. The relative dimensions of the box section allow for different positioning of the bin handle allowing the bolt and nut to be done up in a variety of situations.

While the above has been described, in particular, as a bracket for the attachment of a sanitizer to a wheelie bin, it is to be understood that the bracket could be used in a number of different circumstances where an article is needed to be fastened over the top edge of a wall.

It will be appreciated that additions to or modification of the above described sanitizing device may be made without departing from the scope of the invention. For example, other types of attachment between the bracket and the sanitizer may be used. It would be possible to have the detent 59 provided with an operating handle to allow it to be moved out of the path of the portion 61 of the end 41 so as to enable the sanitizer and bracket to be separated.

What is claimed as new and desired to be protected by Letters Patent of the United States is:

1. A bracket for attaching a device to the upper part of a wall of a container, the bracket comprising a first part of which secures the device to the wall and a second part adapted to provide rigidity of the bracket when secured in position, said the first part being a generally “S” shaped part with an horizontally extending extension extending from an upper part of said “S” shaped part by means of which said “S” shaped part is connected to said second part through a pivot, the second part being of generally “U” shaped construction, and being movable between a first or open position in which one side of said “U” shaped construction extends parallel to said horizontally extending extension of said first part so as to effectively form an extension thereof and a second side of said “U” shaped construction extending parallel to said first side and being connected thereto by said base part of said “U” shaped construction and a second or closed position in which it forms a substantially box section with said first part.

2. A bracket as claimed in claim 1 and comprising securing means securing said second part in its second position.

3. A bracket as claimed in claim 2, wherein said securing means comprises a nut and a bolt extending between said horizontally extending extension of said first part and the base of said “U” shaped construction of said second part.

4. A bracket as claimed in claim 3 wherein said base of said “U” shaped construction defines a bolt receiving aperture in the form of a slot for adjusting the relative positions of said first and said second parts.

5. A bracket as claimed in claim 1 wherein a lower part of said “5” shaped part has an upwardly extending generally vertical arm which is adapted to be seated in a corresponding slot in the device.

6. A bracket as claimed in claim 1 wherein one of said first and second parts of said bracket is an extrusion.

7. A bracket as claimed in claim 1 wherein both of said first and second parts of the bracket are extrusions.

8. A bracket as claimed in claim 1, wherein said first and second parts of said bracket are aluminum extrusions.

9. A bracket as claimed in claim 1, wherein said first and second parts of the bracket is plastics extrusions.

10. An arrangement comprising a bracket as claimed in claim 1 and a sanitizer positively connected thereto.

11. An arrangement as claimed in claim 10, wherein said sanitizer defines a slot which cooperates with one arm of a lower part of said “S” shaped part and comprises a detent engageable behind a projection on the said one ami whereby said sanitizer is permanently attached to said bracket when the said one arm of said “S” shaped part is pushed into the slot of the sanitizer.
